(19) United States
(12) Patent Application Publication
(10) Pub. No.: US 2005/0217458 A1
(43) Pub. Date: Oct. 6, 2005

(54) 12-D gnomon resonator

(76) Inventor: Eugene LeRoy, Anacortes, WA (US)

Correspondence Address: Eugene LeRoy, 6091 Guemes Island Road, Anacortes, WA, 98221, US

(21) Appl. No.: 10/816,965

(22) Filed: Apr. 5, 2004

(51) Int. Cl. G01C 17/34; G01C 21/02; G04B 49/00; G09B 15/02

(52) U.S. Cl. 84/483.2

(57) ABSTRACT

The 12-D Gnomon Resonator is a rotating continuum, a chamber, indicating by the geometry of its construct and attending mathematics a specific angle of incidence relevant to the source of power creating its period of rotation. The initial concept from which the device developed considered the gnomon as a single atom rotating within the field of its subtended curvature; i.e., the electromagnetically charged molecule. Upon a deciphering of the glyph given of FIG. 1A it was realized that Earth itself might well describe such a gnomon; which is to say, one of a series of rotating bodies comprising that molecule we recognize as our solar system. The mathematics was already established, it only remained to relate the period of rotation to a specific angle of incidence with the diurnal arc when at maximum resonance. The invention defines that angle of incidence (western horizon in the plane of the sun) as precisely 50.625 degrees. The critical moment of that occurrence for any given dimension of the device is given by Table 1B.

### BACKGROUND OF INVENTION

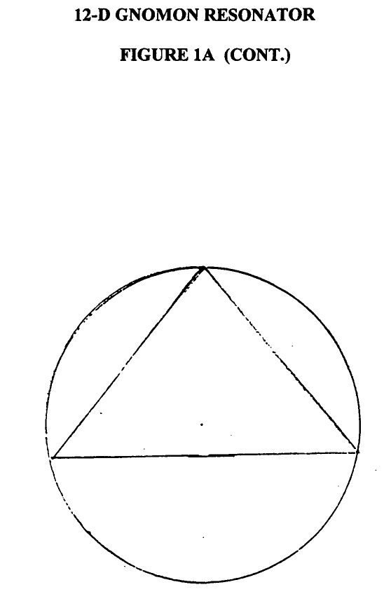

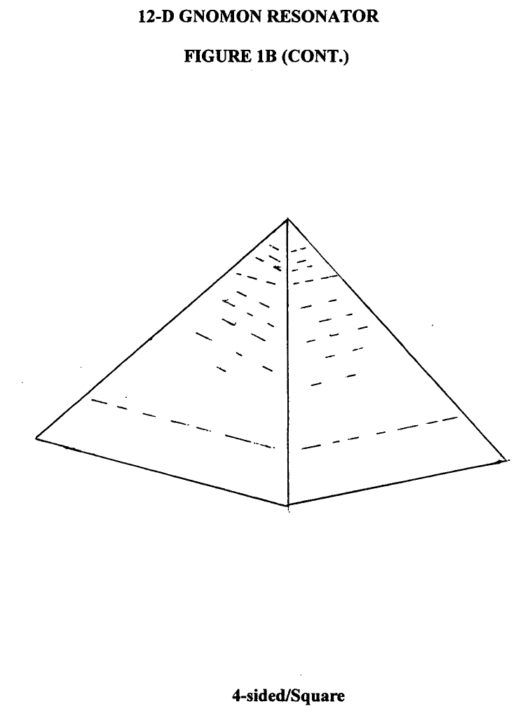

The invention fundamentally derives from findings relevant to the sciences of mathematics and physics: (1) a 12-Tone Scientific Scale (copyright), Table 1A; and (2) the deciphering of an archeologic glyph, FIG. 1A. The Scale in turn derives from a finite mathematic algorithm.

### SUMMARY

The invention has multiple purpose relevant to both practical application and to the field of scientific research. It is through the former, principally the discipline of plant husbandry, that the device finds eloquent proving and as employed in this application for patent to defining its parameters.

TABLE 1A
12-TONE SCIENTIFIC SCALE
The 12-Tone Scientific Scale puts forward a series of proven mathematic
ratios. Ostensibly the Scale describes all exacting relationships that can
possibly exist between the negative and positive exchange of molecular
motion. For sake of convenience the scale is given the same notation as
that of the music scale, noting that 5 of the intervals correspond to ratios
of the 7-tone diatonic scale. The polarity of each interval is as shown.

| | |
|---|---|
| F#: 1.40466392318 (+) | C: 2.0 (+) Fundamental |
| C#: 1.05349794239 ((−) | G: 1.5 (−) |
| G#: 1.58024691358 (+) | D: 1.125 (+) |
| D#: 1.18518518518 (−) | A: 1.6875 (−) |
| A#: 1.77777777777 (+) | E: 1.265625 (+) |
| F: 1.33333333333 (−) | B: 1.8984375 (−) |

TABLE 1B
7-TONE DOMINANT SCALE
Just as the 12-tone music scale derives fron the 7-tone scale of ratios given
by Pythagoras so likewise the 12-Tone Scientific Scale gives 7 dominant
intervals by which any dimensions desired of the invention are readily
found; i.e., multiplying or dividing any of the 7 dominant intervals to any
extent gives diameter of the circle (FIG. 1A) by which physical
dimensions of the continuum are to be derived. For example, the
control program employed through the discipline of plant husbandry
(seed germination and pollination) was advantaged by configuration of
the B interval, thus giving diameter of the circle as 7.59375 inches and
feet respectively. Accordingly, it is seen where in either instance the
specific angle of incidence (50.625 degrees) is realized at the time
specified. FIG. 1B gives other factors to be taken into consideration.

| | |
|---|---|
| B = 3:22.5 PM | G = 2:40 PM |
| E = 4:30 PM | C = 3:33.333 PM |
| A = 3:00 PM | F = 2:22.222 PM |
| D = 4:00 PM | |

FIG. 1A

### Archeologic Glyph

This glyph was found inscribed upon the capstone of a submerged ruin in the Southern clime. Considering that the same glyph is also seen inscribed over the entrance way to the Great Pyramid, and that edifice historically noted to be an instrument for astrological observance, it could reasonably be assumed that the circle represents circumference of Earth's uppermost atmosphere and subtended figure of the isosceles triangle as representing the dimensions of this continuum relevant to some particular moment of occurrence on the diurnal arc. The critical factors determining a deciphering of the glyph, other than the mathematics giving it function, are length to the baseline of the isosceles triangle and purpose to the attending angle of incidence given by its sides. Overall height to the continuum, regardless of its dimensions, was found in dividing diameter of the circle by ratio of the A# interval.

FIG. 1B

The device is a 4sided pyramid shaped chamber constructed and sheathed of any non-metallic material Corner standpoints of the chamber are mitered on the ends and fixed upon a base in such manner as base to each side has a vertical height to the apex as dictated by the desired dimensions (Table 1B). It is essential that: (1) the chamber be leveled and its North side geophysically oriented to magnetic North; (2) that subject material within the device be centered and positioned on a platform extending above the baseline at a distance determined by dividing the overall height by ratio of the A interval (lower dotted line); and (3) that an adequate air hole (say, 3-inch diameter for an overall height of 6 feet) be centered on the East and West sides of the chamber at a vertical distance given in dividing the overall height by ratio of the F interval (upper dotted line). The length to standpoints of the device which meet at its apex is given in dividing diameter of the circle (FIG. 1A) by the square root of 2 (trianglature formula), the standpoint being the hypotenuse to a right angle triangle.

1. What I claim to be my invention is a rotating body that provides by the strict dimensions of its physical construct, derived mathematics and means of fabrication a rotating gnomon indicating that critical moment when the dynamics of the device are in highest possible resonance with that source of power the continuum subtends.
